(19) United States
(12) Patent Application Publication
(10) Pub. No.: US 2024/0412659 A1
(43) Pub. Date: Dec. 12, 2024

(54) WRITING DEVICE

(71) Applicant: Evgenii Valerevich PAIKACHEV, Murmansk (RU)

(72) Inventor: Evgenii Valerevich PAIKACHEV, Murmansk (RU)

(21) Appl. No.: 18/576,093

(22) PCT Filed: Mar. 30, 2022
(86) PCT No.: PCT/RU2022/050105

§ 371 Date: Jul. 29, 2024

(30) Foreign Application Priority Data
Jul. 27, 2021 (RU) 2021122143
Aug. 6, 2021 (RU) 2021123457

(51) Int. Cl. G09B 11/02

(52) U.S. Cl. CPC G09B 11/02

(57) ABSTRACT

The group of inventions relates to devices for training the user's fine motor skills and can be used for developing writing or drawing skills, as well as for restoring impaired or lost motor functions in a user.

The essence of the group of inventions consists in a writing device having tactilely distinguishable elements for training the user's writing and drawing skills, and a tip that is retractable under a certain magnitude of pressing force. The technical result toward which the invention is directed is that of allowing more accurate positioning of the writing device in the user's hand, while simplifying the structure of the writing device and reducing the risk of defects occurring in the components thereof. 3 indep. cl. 19 dep. cl., 7 dwg.

### DISCLOSURE

The group of inventions relates to devices for training the user's fine motor skills and can be used for developing writing or drawing skills, as well as for restoring impaired or lost motor functions in a user.

### PRIOR ART

A writing device is known that comprises a housing and a rod with a tip, wherein the housing expands from the tip of the rod to the central part, and on the side of the tip of the rod, the housing has concave and convex surfaces that are arranged triangularly relative to each other for the user's index finger, middle finger, and thumb [CN100450791, published: Jan. 14, 2009, IPC: B43K 21/00; B43K 23/008; B43K 5/00].

A disadvantage of the known writing device is the high muscle tension in the user's wrist that occurs when the user is training their writing or drawing skills due to the lack of fixation of the writing device's housing relative to the user's palm, which results in the risk of developing various diseases such as muscle contracture, writer's cramp, or neurosis.

Therefore, as a prototype of one technical solution, a writing device comprising a housing and a rod with a tip was selected, wherein the housing expands from the tip of the rod to the central part, on the side of the tip of the rod, the housing has concave elliptical recesses that are arranged triangularly relative to each other for the user's index finger and thumb, and there is a surface for placing the writing device on the user's middle finger, and the housing has an abutting protrusion in the area of the central part for the user's palm [US2016229219A1, published: Aug. 11, 2016, IPC: B43K 23/008; B43K 29/08; G09B 11/02].

The advantage of the prototype is the ability to redistribute the load from the fingers to the user's palm due to the presence of an abutting protrusion, which allows reducing muscle tension in the user's wrist that arises when training writing or drawing skills while maintaining the mobility of the user's wrist. However, a disadvantage of the prototype is the great difficulty in controlling the relative position of the user's index finger and thumb on the device housing when training writing or drawing skills due to the fact that the concave elliptical recesses for the user's index finger and thumb, although they provide the ability to indicate the principle location of the user's fingers on the device housing, do not give the user any idea of how exactly the index finger and thumb should be oriented relative to each other, as the writing device can be used both for training writing skills and for training drawing skills, while the index finger and thumb are also positioned differently in different modes. In the first instance, the user places the fingers in the recess closer to the central part of the housing to engage the movement of the entire wrist, and in the second instance, they place them closer to the tip of the writing device to engage fine motor skills. Due to said disadvantage, when training drawing skills, the user may position the tip of their index finger in the concave elliptical recess closer to the tip of the device, while the user may occasionally accidentally move the tip of the thumb along the surface of the concave elliptical recess toward the central or side part of the housing. This leads to incorrect positioning of the writing device in the user's hand, increased fatigue, and in the worst case, possible deterioration of posture and development of carpal tunnel syndrome in the user, significantly reducing the effectiveness of training the user's writing or drawing skills and deteriorating the performance characteristics of the writing device.

A writing device is also known from the prior art that comprises a housing with an element for determining the pressure point and a channel inside of which a battery, a controller, and a pressure sensor are mounted, and a rod consisting of a tip and a tube is movably supported, wherein the tube abuts the pressure sensor, which is connected to the controller, and the controller, in turn, is connected to a pressure point detection device and a battery [CN105856907, published: Aug. 17, 2016, IPC: B43K 24/02; B43K 29/08; B43K 29/087].

A disadvantage of the known writing device is the high complexity and low reliability of its design due to the use of a pressure point detection element, a pressure sensor, a controller and a battery connected to each other for training writing or drawing skills, which are electronic components and have a high risk of failure when sudden alternating loads occur, caused, for example, when the writing device falls off a table.

A writing device is known that comprises a housing with channels, inside of which, on both sides, cylinders are movably supported to which tubes with tips are attached, with a permanent magnet mounted between the cylinders, and a spring mounted between one of the cylinders and the permanent magnet [JP3022212, published: Mar. 22, 1996, IPC: G09B 19/24].

For this purpose, as a prototype of the second technical solution, a writing device was selected that comprises a housing with channels, inside of which, with a minimum gap, all-metal rods consisting of tubes are movably supported, on one side of which there is a tip and on the other side there are flat areas, wherein each channel has a spring abutting the flat area and the end of the channel, and an indicator is installed outside the housing to control the degree of recessing of the all-metal rod during the writing process [JPH05147381, published: Jun. 15, 1993, IPC: B43K 29/00; B43K 3/04; G09B 11/02].

The advantage of the known writing device and prototype is their simpler and more reliable design due to the use of springs and permanent magnets that interact with the cylinder and rod, as well as the all-metal rods and springs with indicators, which are less susceptible to alternating loads, for training the user's writing or drawing skills, which makes it possible to eliminate electronic components from their design. However, significant disadvantages of the prototype and the known writing device remain the high complexity and low reliability of their design, as instead of electronic components, they use a complex kinematic circuit of movable and stationary elements fixed inside the housing's channels, which can lead to jamming of movable elements, including the cylinders or all-metal rods inside the channels during operation of the writing device and when using it to train writing or drawing skills, as well as to the wear and destruction of springs, or failure of stationary elements, including the gradual demagnetization of the permanent magnet or loss of its fixation in the channel, as a result of which a defect in the writing device may occur and the user may lose the ability to use it to train writing or drawing skills.

### SUMMARY OF THE DISCLOSURE

The essence of the first invention from the group of inventions is as follows.

The writing device comprises a housing and a movably supported rod consisting of a tip and a tube, wherein a part of the tip protrudes from the channel of the housing, wherein the housing expands from the tip of the rod to the central part, and on the side of the tip of the rod, the housing has concave elliptical recesses that are arranged triangularly relative to each other for the user's index finger and thumb and a surface for placing the writing device on the user's middle finger, and the housing has an abutting protrusion in the area of the central part for the user's palm. In contrast to the prototype, on the surface of each concave elliptical recess on opposite sides of its center there is a tactilely distinguishable element, one of which is intended for training the user's writing skills while the other is intended for training the user's drawing skills, wherein the distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess, the tube is made of an elastically deformable material, and the size of the gap between the channel wall and the surface of the tube is equal to at least one length of that part of the rod tip that protrudes from the housing channel.

The essence of the second invention from the group of inventions is as follows.

The writing device comprises a housing and a rod with a tip, wherein the housing expands from the tip of the rod to the central part, and on the side of the tip of the rod, the housing has concave elliptical recesses that are arranged triangularly relative to each other for the user's index finger and thumb and a surface for placing the writing device on the user's middle finger, and the housing has an abutting protrusion in the area of the central part for the user's palm. In contrast to the prototype, on the surface of each concave elliptical recess on opposite sides of its center there is a tactilely distinguishable element, one of which is intended for training the user's writing skills, and the other is intended for training the user's drawing skills, wherein the distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess.

The essence of the third invention from the group of inventions is as follows.

The writing device comprises a housing with a channel having a movably supported rod therein that consists of a tip and a tube, wherein a part of the tip protrudes from the housing channel. In contrast to the prototype, the tube is made of an elastically deformable material, and the gap between the channel wall and the surface of the tube is equal to at least one length of that part of the rod tip that protrudes from the housing channel, allowing the protruding part of the tip to be immersed into the channel if the pressing force applied by the user on the writing device is exceeded, and returning the protruding part of the tip to its original state when the user's pressure on the writing device decreases, wherein the required amount of pressing force on the writing device, at which the protruding part of the tip is immersed into the channel, is ensured by preloading the tube, for which purpose the channel is shorter than the tube.

The rod consists of a tip and a tube. The tip is connected at one end to the tube, while its other end may contain a spherical, cylindrical, or cone-shaped contact element, or it may contain a writing element in the form of a ball or stylus. It is also possible that the entire tip is provided in the form of a stylus. The tube is made of an elastically deformable material, which makes it possible to repeatedly change the shape of the tube profile and return it to its original state. Such materials can include metals, polymers, or composites that have elastic deformation properties, such as spring steel, plastic, or fiberglass composite.

The housing ensures the load-bearing functions of the writing device. The housing can be made of construction material of any type. The housing expands from the tip of the rod to the central part, which allows for more accurate positioning of the writing device in the user's hand. On the side of the rod tip, the housing has concave elliptical recesses that are arranged triangularly relative to each other for the user's index finger and thumb and a surface for placing the writing device on the user's middle finger. By triangular arrangement of elements is meant that they represent one of the parts of the housing and are arranged relative to its longitudinal axis so that the concave elliptical recesses for the user's index finger and thumb are located on adjacent parts of the housing, and the surface for placing the writing device on the middle finger of the user is located opposite to them.

The housing on the outer surface may have recesses and/or abutments and/or concavities for the user's fingers. The housing can be made of construction material of any type.

Concave elliptical recesses for the user's index and thumb can be formed by second-order curves, wherein the ellipse representing the base for each recess can be positioned with foci aligned with the longitudinal axis of the housing.

On the surface of each concave elliptical recess, on opposite sides of its center, there are tactilely distinguishable elements, one of which is intended for training the user's writing skills, and the other is intended for training the user's drawing skills, which reduces the risk of inconsistent changes in the relative position of the user's fingers on the writing device housing and allows for more accurate positioning of the writing device in the user's hand. The distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess. When training writing skills, this makes it possible to identify the positions of the user's index finger and thumb in the concave elliptical recess, located closer to the central part of the housing. When training drawing skills, this makes it possible to identify the positions of the user's index finger and thumb in the concave elliptical recess closer to the tip of the writing device. In a most preferred embodiment, the distance from the tip of the rod to the tactilely distinguishable element intended for training the user's writing skills may exceed the distance from the tip of the rod to the tactilely distinguishable element intended for training the user's drawing skills by at least 30%, which allows for more accurate positioning of the writing device in the user's hand. This limit is determined by the possibilities of tactile identification of a particular element, as well as the potential decrease in the effectiveness of training the user's writing or drawing skills if they are closer.

Tactilely distinguishable elements can be provided as a protrusion or additional recess, or roughness on the surface of a concave elliptical recess or other similar elements. Moreover, tactilely distinguishable elements located on the surfaces of different concave elliptical recesses, but intended for training the same user skill, can be of different type or the same type.

Furthermore, for more accurate positioning of the writing device in the user's hand, the tactilely distinguishable elements for the writing skills and/or drawing skills can have an anti-friction effect. For this purpose, the tops of the tactilely distinguishable elements for training writing skills can be directed toward the central part of the housing, and the tops of the tactilely distinguishable elements for training drawing skills can be directed toward the tip.

Furthermore, for more accurate positioning of the writing device in the user's hand, the depth of that part of the concave elliptical recess that is located closer to the central part of the housing may exceed the depth of the part that is located closer to the tip. Moreover, for more accurate positioning of the writing device in the user's hand when training drawing skills, a tactilely distinguishable element intended for training the user's writing skills can be located at the bottom of the concave elliptical recess.

Furthermore, for more accurate positioning of the writing device in the user's hand, the tactilely distinguishable element intended for training writing skills can be provided as a funnel made at the bottom of a concave elliptical recess, making it possible to increase the positioning accuracy of the fingertips when training writing skills. Similarly, a tactilely distinguishable element intended for training drawing skills can be made. Also, a protrusion can be further located at the bottom of the funnel, making it possible to create an additional force for pressing the housing with fingertips to the user's palm and increase the positioning accuracy of the writing device in the user's hand. Moreover, the height of the protrusion can be less than the funnel depth, which also further increases the positioning accuracy of the fingertip in the elliptical recess and increases the positioning accuracy of the writing device in the user's hand.

The surface for placing the writing device on the user's middle finger makes it possible to fix the writing device in the user's hand and may have a concave or convex shape. The housing has an abutting protrusion in the area of the central part for the user's palm that makes it possible to redistribute the load from the fingers to the user's palm and reduce muscle tension in the user's wrist that occurs when training writing or drawing skills. Moreover, to increase the efficiency of redistributing the load from the fingers to the user's palm, the abutting protrusion for the user's palm can be located on the same side relative to the longitudinal axis of the housing with the surface for placing the writing device on the user's middle finger. Furthermore, to further increase the efficiency of redistributing the load from the fingers to the user's palm, the abutting protrusion for the user's palm can be barrel-shaped. Also, to further improve the efficiency of redistributing the load from the fingers to the user's palm, the abutment for the user's palm can be extended, providing additional abutment in the middle of the user's palm. It is also possible that the abutment for the user's palm can be made at different angles relative to the longitudinal axis of the housing to enable it to abut different parts of the palm and further increase the positioning accuracy of the writing device in the user's hand.

Furthermore, to allow for more accurate positioning of the writing device in the user's hand, anti-friction elements may be provided on the surface of the abutting protrusion for the user's palm. In this case, the anti-friction elements can be provided as a group of protrusions. Additionally, the funnel, at the bottom of which is a protrusion intended for training writing skills, can be oriented longitudinally to the abutting protrusion for the user's palm, which makes it possible to further increase the force of pressing the housing by the abutting protrusion to the user's palm and to increase the positioning accuracy of the writing device in the user's hand.

Additionally, anti-friction elements located on the surface of the abutting protrusion for the user's palm, as well as tactilely distinguishable elements for training writing skills and/or for training drawing skills providing an anti-friction effect can be made as a housing part or as separate elements. In this case, to ensure the anti-friction effect, some elements can be made of materials different from the housing material.

The channel provides the ability to place and movably secure the rod inside the housing. The channel's longitudinal profile can be either straight or curved. Moreover, the channel is made open on one side of the housing, while on the other side of the housing, the channel can be configured to prevent the outward linear movement of the rod from the housing. For this purpose, the channel can be made closed, covered with a lid or plug, or it can have a protrusion that prevents the rod from moving outward from the housing. In this case, on the opposite open side of the housing channel, there may be an element that ensures the tip of the rod is movably secured in the housing. This element can be made as a protrusion in the channel, a narrowing of the channel or a cap, which form or have an opening that provides linear movement of the tip in the housing.

The size of the gap between the channel wall and the surface of the tube is equal to at least one length of the part of the tip of the rod that protrudes from the housing channel, which makes it possible to immerse the protruding part of the tip into the channel when the permissible pressing force on the writing device is exceeded, preventing the use of the writing device and training the user's writing or drawing skills. In this case, the pressing force on the device ensuring complete immersion of the protruding part of the tip into the channel can range from 0.5 to 2.5 kg*m/s². If this value is less than 0.5 kg*m/s², the required pressing force on the device at which the protruding part of the tip will be completely immersed into the channel will be too small, making it impossible to train the pressing force on the writing device and train the user's writing or drawing skills. If this value exceeds 2.5 kg*m/s², the pressing force on the device required to completely immerse the protruding part of the tip into the channel will be too great, and, as a result, it will also become impossible to train the user's writing or drawing skills. In this case, the required pressing force on the writing device at which the protruding part of the tip will be completely immersed into the channel can be provided through the type of elastically deformable material from which the tube is made, or by preloading the tube. In this case, to ensure the tube is preloaded, the channel may be shorter than the tube.

To obtain the required gap or sum of gaps, the channel may have an extension along its entire length, or it may have at least one extension, which can be formed using a second- or third-order curve. In a most preferred embodiment, the channel is curved, and the extension is made at the point where the channel bends, for example at the top of the bend or along the entire length of the bend. Moreover, the channel may contain more than one bend, and each of them may have an extension. In this case, the size of the gap between the channel wall and the surface of the tube can be proportional to the number of extensions, which reduces the deformation of the tube and reduces the risk of a defect, thus increasing the reliability of the writing device.

### Technical Problem

The technical problem for which the group of inventions is designed is the need to improve performance characteristics while increasing the reliability of the writing device.

### Problem Solution

The technical problem is solved via the following:
there is a tactilely distinguishable element on the surface of each concave elliptical recess, on opposite sides of its center, one of which is intended for training the user's writing skills and the other is intended for training the user's drawing skills, wherein the distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess, which makes it easier to control the relative position of the user's index finger and thumb on the device housing when training writing or drawing skills and to indicate the principal location of the user's fingers on the device housing.
the tube is made of an elastically deformable material making it possible to repeatedly change the shape of the tube profile and return it to its original state, which allows the protruding part of the rod tip to move linearly relative to the housing.
the size of the gap between the channel wall and the surface of the tube is equal to at least one length of the part of the rod tip that protrudes from the housing channel, which allows, during elastic deformation of the tube, ensuring such a cavity in the channel of the device housing, due to which the tube can be folded and the protruding part of the tip can be completely immersed into the housing when the permissible pressing force on the writing device is exceeded.

The set of substantial features makes it possible to orient the index finger and thumb relative to each other, both when training writing skills and when training drawing skills, by placing them in a recess closer to the tip of the writing device to engage the movement of the entire wrist, or closer to the central part of the housing to engage fine motor skills. As a result, when training drawing skills, the user positions the tips of the index finger and thumb in the concave elliptical recesses closer to the tip of the device, and when training the writing skill, positions them closer to the central part of the housing, thereby reducing the risk of the user occasionally accidentally displacing the fingers in the concave elliptical recesses of the device housing. This allows the protruding part of the rod tip to move linearly relative to the housing until it is completely immersed into the housing when the permissible pressing force on the writing device is exceeded, the protruding part of the tip is returned to its original state when the applied pressing force on the writing device is reduced, which prevents the use of the writing device when a certain degree of pressure on the writing device is exceeded, and thus train writing or drawing skills using the writing device only due to the design of elastic deformation of the rod in the gap(s) of the channel without using electronic components or complex kinematic circuits in the design of the writing device.

This ensures the achievement of a technical result, which consists of allowing more accurate positioning of the writing device in the user's hand, while simplifying the structure of the writing device and reducing the risk of defects occurring in the components thereof, thereby improving the performance characteristics of the writing device and increasing its reliability.

Writing devices are known from the prior art, one of which has concave and convex surfaces on the housing for the user's index finger and thumb, and the other has concave elliptical recesses on the housing for the user's index finger and thumb. Writing devices are also known from the prior art, through which the user's writing or drawing skills are trained, which are based on the use of electronic systems for monitoring the pressing degree, as well as based on kinematic circuits providing control over the degree of pressing on the writing device. The known devices solve the set problem and provide high efficiency in training the user's writing or drawing skills but have a complex design.

Moreover, a writing device is known from the prior art, wherein on the surface of each concave elliptical recess, on opposite sides of its center, there are tactilely distinguishable elements, one of which is intended for training the user's writing skills, and the other is intended for training the user's drawing skills. In addition, it is not known if such a writing device would be as highly effective in training the user's writing or drawing skills, have a simple and sturdy design and would be based on the effect of elastic deformation of the tube and its movement in the channel gap to such an extent that the protruding part of the tip is completely immersed into the housing when the permissible pressing force on the writing device is exceeded and the protruding part of the tip is returned to its original state when the pressing force on the writing device is reduced, and thus training the user's writing or drawing skills.

### Advantageous Effects of the Invention

The technical result toward which the group of inventions is directed is that of allowing more accurate positioning of the writing device in the user's hand, while simplifying the structure of the writing device and reducing the risk of defects occurring in the components thereof.

### BRIEF DESCRIPTION OF THE DRAWINGS

This is a sample text. Does non-payment, incomplete payment or late payment of fees influence the international filing date? The reply to this question is in the negative. However, those defects will eventually lead the receiving Office to declare that the international application is, or certain designations are, considered withdrawn (see paragraphs 213 and 214). Although an international application which has not been accorded an international filing date and an international application which is considered withdrawn are both excluded from further processing in the international phase, an international application which fulfills the requirements necessary for it to be accorded an international filing date may be invoked as a priority application under the Paris Convention for the Protection of Industrial Property (if the conditions laid down by that Convention are fulfilled) even where the international application is considered withdrawn under the PCT (for non-payment of fees or other reasons).

FIG. 1 A writing device, the housing has an abutting barrel-shaped protrusion in the area of the central part for the user's palm, the said protrusion is located on one side relative to the longitudinal axis of the housing, with a surface for placing the writing device on the user's middle finger, wherein the depth of the part of the concave elliptical recess which is located closer to the central part of the housing exceeds the depth of the part of it that is located closer to the tip, and the tactilely distinguishable element intended for training the user's writing skills is located at the bottom of a concave elliptical recess and is made as a protrusion located in a funnel, isometric view.

FIG. 2 The writing device according to FIG. 1, with the cross-section of the area of the concave elliptical recess made in the direction of the tip.

FIG. 3 The writing device according to FIG. 1, with the cross-section of the area of the concave elliptical recess made in the direction of the central part of the device.

FIG. 4 A writing device comprising a curved channel, wherein the gap between the channel wall and the surface of the tube is equal to at least one length of the part of the rod tip that protrudes from the housing channel, longitudinal section.

FIG. 5 The writing device according to the figure, wherein the protruding part of the tip is immersed into the channel, longitudinal section.

FIG. 6 A writing device comprising a curved channel, wherein the gap between the channel wall and the surface of the tube exceeds the length of the part of the rod tip that protrudes from the housing channel, longitudinal section.

FIG. 7 The writing device according to FIG. 6, wherein the protruding part of the tip is immersed into the channel, longitudinal section.

### DISCLOSURE OF EMBODIMENTS

To illustrate the implementation and ensure a more complete understanding of the essence of the group of inventions, an embodiment is provided below, which can be changed or supplemented in any way, wherein the present group of inventions is not limited to the provided embodiment in any way.

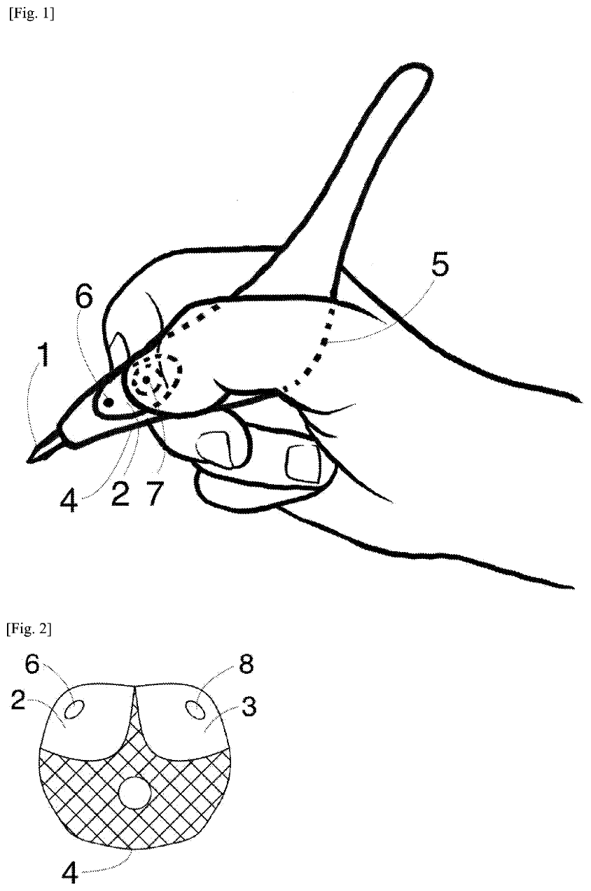

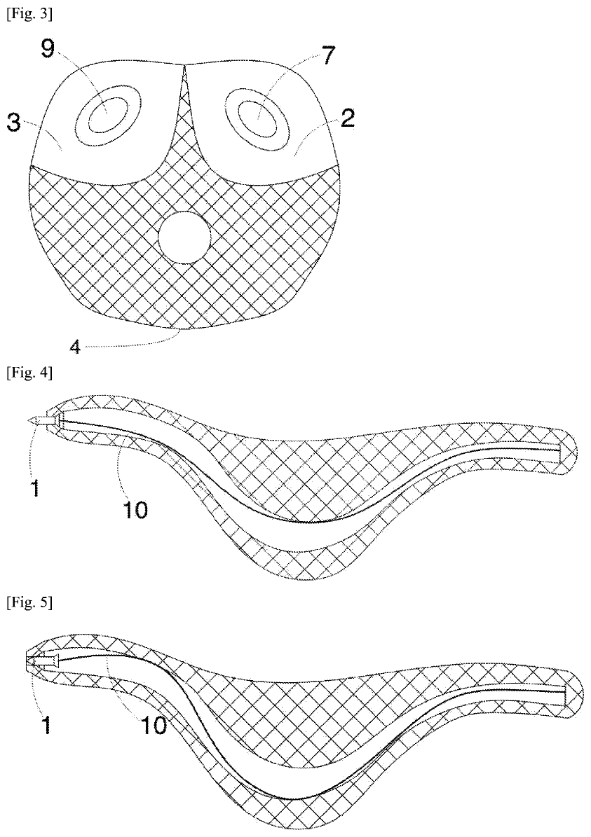

The writing device (FIGS. 1-3) comprises a housing (not shown in the figures), inside of which a rod (not shown in the figures) with tip 1 is fixed. The housing expands from the tip 1 to the central part, and on the side of the tip 1 it has, in a triangular arrangement: a concave elliptical recess 2 for the user's thumb, a concave elliptical recess 3 for the user's index finger, and a surface 4 for placing the device on the user's middle finger, located opposite the concave elliptical recesses 2 and 3. In this case, in the area of the central part, the housing has an abutting protrusion 5 with an area of anti-friction bulges for the user's palm, located on one side of the housing with the surface 4 for placing the device on the user's middle finger. Moreover, the elliptical recesses 2 and 3 each have a pair of tactilely distinguishable protrusions 6, 7, 8, and 9, which are located on the surface of the elliptical recesses 2 and 3 on opposite sides of their centers, while the protrusions 6 and 8 are designed to accommodate the user's thumb and index finger when training the user's drawing skills and provide an anti-friction effect, and the protrusions 7 and 9 are designed to accommodate the user's thumb and index finger when training the user's writing skills and are located in an additional funnel. In this case, the distance from the tip 1 to the protrusion 7 of the concave elliptical recess 2 exceeds the distance from the tip 1 to the protrusion 6, and accordingly, the distance from the tip 1 to the protrusion 9 of the concave elliptical recess 3 exceeds the distance from the tip 1 to the protrusion 8.

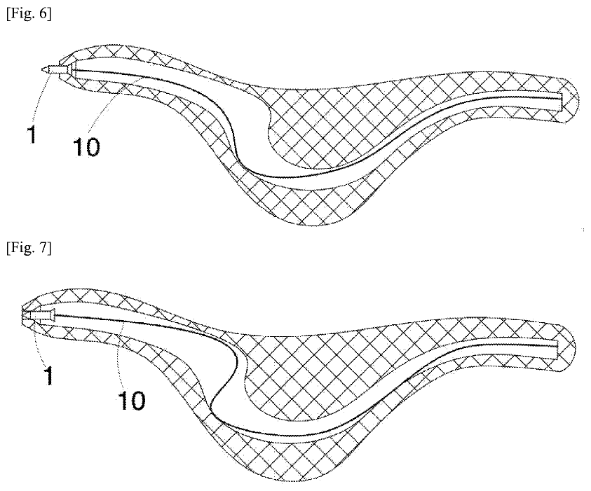

Furthermore, the writing device (FIGS. 4-7) housing has a channel, inside of which a rod consisting of a tip 1 and a tube 10 filled with paste ink is movably fixed. In this case, the tip 1 is movably mounted in the hole of the channel and abuts one end, and the tube 10 abuts the opposite end of the channel. Furthermore, the channel has a curved profile, the tube 10 is made of elastically deformable plastic, and the length of the channel is less than the length of the tube 10, thus creating preloading of the tube 10, and the gap between the channel wall and the surface of the tube 10 is equal to at least one length of the part of the tip 1 that protrudes from the channel.

The group of the inventions operates as follows.

The writing device (FIGS. 1-3) is placed in the user's hand, and the user's thumb and index finger are placed in the concave elliptical recesses 2 and 3, while the surface 4 of the device is placed on the surface of the user's middle finger, and the protrusion 5 abuts the device against the user's palm. When the user operates the writing device, the index finger and thumb are located on the protrusions 6 and 8, and the angle formed between the index finger and thumb of the device's user is reduced, which allows the user to train the drawing technique and, due to the anti-friction effect, the risk of the thumb and index finger slipping to the tip 1 is reduced. Then, the user moves the index finger and thumb along the concave elliptical recesses 2 and 3 to the protrusions 7 and 9, respectively, while the location of the index finger and thumb on them allows the joint to bend and increases the angle formed between the index finger and thumb of the device's user, which allows the user to train the writing technique. In this case, due to the fact that the pressing degree of the abutting protrusion 5 to the user's palm increases, and the rigidity of fixing the device in the user's hand increases. Due to the provided design of the writing device, when training drawing skills, the user positions the tips of the thumb and index finger in the concave elliptical recesses 2 and 3, closer to the tip 1 of the device, and when training writing skills, positions them closer to the central part of the housing, thereby reducing the risk of the user occasionally accidentally displacing the fingers in the concave elliptical recesses 2 and 3 of the device housing.

The writing device (FIGS. 4-7) is placed in the user's hand, with the housing positioned between the middle finger, index finger, and thumb of the user's hand. When training the writing or drawing technique, the writing tip 1 is moved along the paper medium, and paste ink is transferred to the paper medium. This process is carried out with a concomitant increase in the user's pressing force on the device's housing, which is subsequently transferred to the writing tip 1, leading to linear movement of the writing tip 1 in the hole and its partial or complete immersion into the channel, depending on the pressing force the user applies to the housing. Depending on how much the user reduces the pressing force applied to the housing, due to tube 10 abutting the end of the channel and the appearance of a bending moment within the profile of the tube 10, a reverse linear movement of the tip 1 in the hole occurs and it partially exits the channel, or it exits until abutting the channel edges. Thus, the protruding part of the tip 1 is completely immersed into the housing when the permissible pressing force on the writing device is exceeded and the protruding part of the tip 1 is returned to its original state when the pressing force on the writing device is reduced, improving the user's smooth writing or drawing skills and developing their fine motor skills without using complex electronic systems for monitoring the pressure degree on the writing device, as well as kinematic circuits that provide control over the pressure degree on the writing device.

During the operation of the provided writing devices, the load is redistributed from the fingers to the palm and muscle tension is reduced, but mobility is maintained, and the movements of the user's wrist are not constrained.

### INDUSTRIAL APPLICABILITY

The group of the inventions can be made of known materials using known means, which indicates its compliance with the patentability criterion of industrial applicability.

### PATENT LITERATURE

Patent literature 1: Patent document CN100450791
Patent literature 2: Patent document US2016229219A1
Patent literature 3: Patent document CN105856907
Patent literature 4: Patent document JP3022212
Patent literature 5: Patent document JPH05147381

1. A writing device comprising a housing and a movably supported rod consisting of a tip and a tube, wherein a part of the tip protrudes from the housing channel, wherein the housing expands from the tip of the rod to the central part, and on the side of the tip of the rod, the housing has concave elliptical recesses that are arranged triangularly relative to each other for the user's index finger and thumb and a surface for placing the writing device on the user's middle finger, and in the area of the central part, the housing has an abutting protrusion for the user's palm, characterized in that there are tactilely distinguishable elements on the surface of each concave elliptical recess, on opposite sides of its center, one of which is intended for training the user's writing skills, and the other is intended for training the user's drawing skills, wherein the distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess, the tube is made of an elastically deformable material, and the size of the gap between the channel wall and the surface of the tube is equal to at least one length of the part of the rod tip that protrudes from the housing channel.

2. A writing device comprising a housing and a rod with a tip, wherein the housing expands from the tip of the rod to the central part, and on the side of the tip of the rod, the housing has concave elliptical recesses that are arranged triangularly relative to each other for the user's index finger and thumb and a surface for placing the writing device on the user's middle finger, and in the area of the central part, the housing has an abutting protrusion for the user's palm, characterized in that there are tactilely distinguishable elements on the surface of each concave elliptical recess, on opposite sides of its center, one of which is intended for training the user's writing skills, and the other is intended for training the user's drawing skills, wherein the distance from the tip of the rod to the tactilely distinguishable element intended for training the user's writing skills of one concave elliptical recess exceeds the distance from the tip of the rod to the tactilely distinguishable element intended for training the user's drawing skills of the same concave elliptical recess.

3. The writing device according to claim 2, characterized in that the distance from the tip of the rod to the tactilely distinguishable element intended for training the user's writing skills exceeds the distance from the tip of the rod to the tactilely distinguishable element intended for training the user's drawing skills by at least 30%.

4. The writing device according to claim 2, characterized in that the tactilely distinguishable elements for training the user's writing skills and/or for training the user's drawing skills provide an anti-friction effect.

5. The writing device according to claim 2, characterized in that tops of tactilely distinguishable elements for training the user's writing skills are directed towards the central part of the housing to provide an anti-friction effect.

6. The writing device according to claim 2, characterized in that the depth of the part of the concave elliptical recess that is located closer to the central part of the housing exceeds the depth of the part that is located closer to the tip.

7. The writing device according to claim 6, characterized in that the tactilely distinguishable element intended for training the user's writing skills is located at the bottom of the concave elliptical recess.

8. The writing device according to claim 7, characterized in that the tactilely distinguishable element intended for training writing skills is provided as a funnel made at the bottom of a concave elliptical recess.

9. The writing device according to claim 8, characterized in that there is a protrusion at the bottom of the funnel.

10. The writing device according to claim 9, characterized in that the height of the protrusion is less than the depth of the funnel.

11. The writing device according to claim 10, characterized in that the funnel, at the bottom of which is a protrusion intended for training writing skills, is oriented longitudinally to the abutting protrusion for the user's palm.

12. The writing device according to claim 2, characterized in that the abutting protrusion for the user's palm is located on one side relative to the longitudinal axis of the housing, with a surface for placing the writing device on the user's middle finger.

13. The writing device according to claim 2, characterized in that the abutting protrusion for the user's palm is barrel-shaped.

14. The writing device according to claim 2, characterized in that the abutting protrusion for the user's palm is extended, which enables additional abutment in the middle of the user's palm.

15. The writing device according to claim 2, characterized in that the abutment for the user's palm is made at an angle relative to the longitudinal axis of the housing to enable abutting different parts of the palm.

16. The writing device according to claim 2, characterized in that the anti-friction elements are made on the surface of the abutment for the user's palm.

17. The writing device according to claim 16, characterized in that the anti-friction elements are provided as a group of protrusions.

18. The writing device according to any of claim 4 or 16, characterized in that the anti-friction elements located on the surface of the abutting protrusion for the user's palm, and/or tactilely distinguishable elements for training writing skills and/or for training drawing skills, providing an anti-friction effect, are made as a part of the housing and/or as separate elements.

19. The writing device according to claim 18, characterized in that some elements are made of different materials to ensure the anti-friction effect.

20. A writing device comprising a housing with a channel, inside which a rod consisting of a tip and a tube is movably supported, with a part of the tip protruding from the channel of the housing, characterized in that the tube is made of an elastically deformable material, and the gap between the channel wall and the surface of the tube is equal to at least one length of the part of the rod tip that protrudes from the housing channel, allowing the protruding part of the tip to be immersed into the channel if the pressing force applied by the user on the writing device is exceeded, and the protruding part of the tip is returned to its original state when the user's pressure on the writing device decreases, wherein the required amount of the pressing force on the writing device, at which the protruding part of the tip is immersed into the channel, is ensured by preloading the tube, for which purpose the channel is shorter than the tube.

21. The writing device according to claim 20, characterized in that the pressing force on the device ensuring complete immersion of the protruding part of the tip into the channel ranges from 0.5 to 2.5 kg*m/s².

22. The writing device according to claim 20, characterized in that the channel is curved, and the expansion is made at the point where the channel bends.
